(19) United States
(12) Patent Application Publication
(10) Pub. No.: US 2004/0191434 A1
(43) Pub. Date: Sep. 30, 2004

(54) Adhesive carrier for stackable blocks

(76) Inventor: Horacio Correia, Lachenaie (CA)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 10/419,694

(22) Filed: Apr. 21, 2003

(30) Foreign Application Priority Data
Mar. 27, 2003 (CA) 2,423,680

(51) Int. Cl. F16L 1/00

(52) U.S. Cl. 428/34.1; 428/43

(57) ABSTRACT

An adhesive carrier for stackable building blocks having respective top and bottom surfaces. The carrier includes a body defining a cavity with an adhesive material contained therein. When placing the body on the top surface of a lower block and stacking an upper block thereon, the body is so configured and sized as to burst between the two stacked blocks releasing the adhesive material contained therein, thereby adhering the two stacked blocks together. The adhesive carrier also includes a body having adhesive material mounted thereon. When placing the body on the top surface of a lower block and stacking an upper block thereon, the adhesive is so configured as to adhere the two stacked blocks together either because of pressure-sensitivity or when chemically reacted with another substance. The adhesive carrier further includes an adhesive interlock connector. Also disclosed is a method of adhering stackable building blocks together.

### FIELD OF THE INVENTION

The present invention relates to an adhesive carrier for stackable blocks. More specifically, the present invention is concerned with an adhesive carrier for stackable blocks that adheres two stacked blocks together when interposed therebetween to be so as to be subjected to pressure exerted by the stacked blocks.

### BACKGROUND OF THE INVENTION

Adhesives for stackable precast concrete building blocks that can be used for a variety of purposes such as in outdoor landscaping wall structures are well known.

Conventionally, in such wall structures an industrial ready-to-polymerize liquid or gel-like industrial adhesive material is spread on the top side of a bottom block. Then, a second or top block is stacked on this bottom block. The bottom side of this second block lies flush with the top side of the first block with the adhesive material interposed therebetween. After a few seconds or minutes the adhesive will polymerize and glue the two stacked blocks together.

One drawback of the prior art is that there is an adhesive spreading step which slows down the block stacking process. Another drawback of the prior art is that the top blocks have to be stacked on the bottom blocks within a certain time frame before the spread adhesive gels and is no longer useful.

### OBJECTS OF THE INVENTION

The general object of the present invention is therefore to provide an improved adhesive for stackable building blocks and method for adhering two stacked blocks together.

### SUMMARY OF THE INVENTION

More specifically, in accordance with the present invention, an adhesive carrier for stackable building blocks having respective top and bottom surfaces, the carrier comprising:

a body defining a cavity; and

an adhesive material contained within the cavity, whereby, when placing the body on the top surface of a lower block and stacking an upper block thereon, the body being so configured and sized as to burst between the two stacked blocks releasing the adhesive material contained therein, thereby adhering the two stacked blocks together.

In accordance with another aspect of the present invention, there is provided an adhesive carrier for stackable building blocks having respective top and bottom surfaces, the carrier comprising:

a body having an outer surface and

a pressure-sensitive adhesive material mounted to the outer surface,

whereby, when interposing the body between two stacked blocks, the stacked blocks exerting such pressure on the pressure-sensitive adhesive material as to adhere the two stacked blocks to the body.

In accordance with a further aspect of the present invention, there is provided an adhesive interlock connector for adhesively interconnecting two stackable blocks having top and bottom surfaces with respective grooves, the interlock connector comprising:

a body having top and bottom body portions, the body being made of an adhesive material, wherein the adhesive body is configured to adhere together two stacked blocks when interposed therebetween with the top body portion being inserted in the groove of the bottom surface of an upper staked block and the bottom body portion being inserted in the groove of the top surface of a lower stacked block.

In accordance with yet another aspect of the present invention, there is provided an adhesive body for adhesively interconnecting two stackable blocks having top and bottom surface, the being made of a solid adhesive material, wherein the adhesive body is configured to adhere together two stacked blocks when interposed between the bottom surface of an upper stacked block and the top surface of a lower stacked block and when chemically reacted with another substance.

In accordance with yet a further aspect of the present invention, there is provided a method of adhering stackable building blocks together, the blocks having respective top and bottom surfaces, the method comprising:

(a) placing an adhesive carrier on the top surface of one block, the adhesive carrier including a body defining a cavity with adhesive material contained therein; and

(b) stacking another block on the top surface of the one block so as to burst the adhesive carrier body releasing the adhesive material between the to stacked blocks, thereby adhering the two stacked blocks together.

In accordance with still yet another aspect of the invention there is provided a method of adhering stackable building blocks together, the blocks having respective top and bottom surfaces, the method comprising:

(a) placing an adhesive carrier on the top surface of a lower block, the adhesive carrier including a body having an outer surface and including a pressure-sensitive adhesive material mounted to the outer surface,

(b) stacking another block on the top surface of the one block so as to exert such pressure on the pressure-sensitive adhesive material as to adhere the two stacked blocks to the body.

In accordance with still yet a further aspect of the present invention, there is provided a method of adhering stackable building blocks together, the blocks having respective top and bottom surfaces with respective grooves, the method comprising:

(a) placing an adhesive interlock connector on the top surface of one block, the adhesive interlock connector including a body made of an adhesive material and having top and bottom body portions, the bottom body portion being inserted in the top surface groove;

(b) stacking another block on the one block such that the bottom surface groove of the another block receives therein the top body portion such that the adhesive body is configured to adhere the two stacked blocks together.

In accordance with still yet another aspect of the present invention, there is provided a method of adhering stackable building blocks together, the blocks having respective top and bottom surfaces, the method comprising:

(a) placing an adhesive body made of a solid adhesive material on one block;

(b) stacking another the block on one tblock with the adhesive body interposed therebetween; and

(c) reacting the solid adhesive body with a substance such that the solid adhesive body is configured to adhere together the two stacked blocks when chemically reacted with the substance.

The term “adhesive carrier” should be construed herein to include without limitation a container, a sac, a cartridge, a blister pad, a capsule, a glue shot container, an inner body carrying an adhesive material thereon or a solid body of adhesive material.

Other objects, advantages and features of the present invention will become more apparent upon reading of the following non restrictive description of preferred embodiments thereof, given by way of example only with reference to the accompanying drawings.

### BRIEF DESCRIPTION OF THE DRAWINGS

In the appended drawings where like reference numerals refer to like elements throughout and in which:

FIG. 1 is a front elevational view of adhesive carriers in accordance with two embodiments of the present invention, the adhesive carriers being placed on a lower building block with an upper block about to be stacked thereon;

FIG. 2 is a front elevational view of the two adhesive carriers of FIG. 1 with the second block having been moved closer to the lower block; and

FIG. 3 is a front elevational view of the adhesive carriers of FIG. 1 between two stacked building blocks.

### DESCRIPTION OF THE EMBODIMENT

With reference to the appended drawings there is shown a preferred embodiment of the adhesive carrier 10 for stackable blocks.

The adhesive carrier 10 is in the form of a burstable container formed by a body 12. Body 12 has a generally oval configuration and defines an internal cavity 14. The cavity 14 is filled with an adhesive material 16. Therefore, container body 12 encapsulates this adhesive material 16.

Body 12, includes a weak breaking area or portion 18.

The adhesive container 10 is used to inter-adhere or glue together at least two stackable building blocks 20 having respective top and bottom sides 22 and 24.

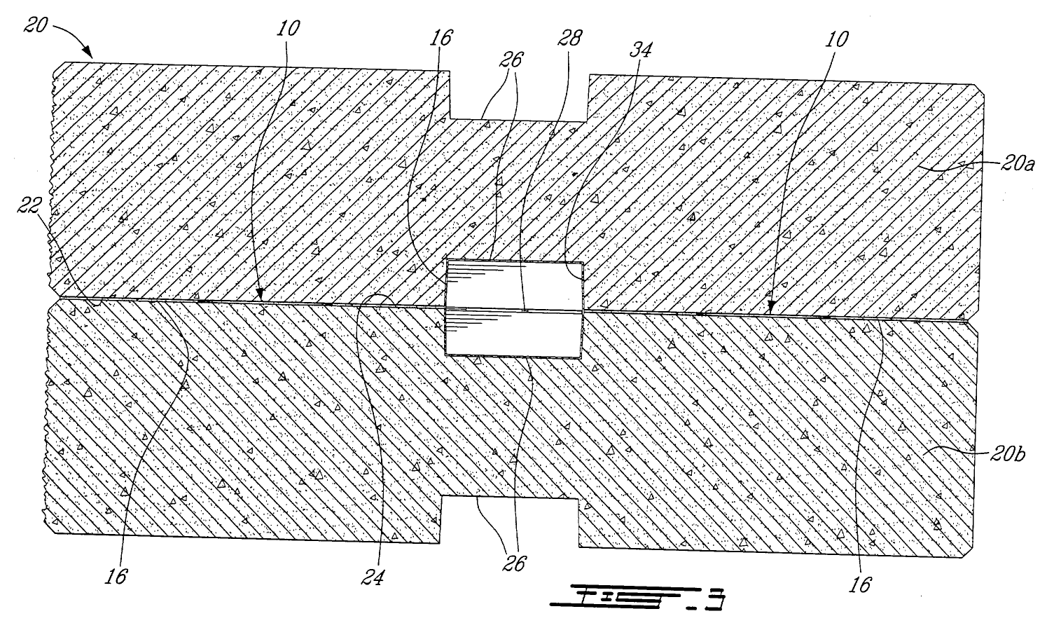

In this example, blocks 20 have a generally rectangular configuration and are provided with respective grooves 26 on their top and bottom sides 22 and 24. In this way and as better shown in FIGS. 2 and 3, an interlock connector 28 is interposed between two stacked building blocks 20 and fitted within grooves 26 formed in surfaces 22 and 24.

In operation, the user places a container 10 on the top surface 22 of a lower block 20a. The container is so positioned as to permit the weak breaking point 18 to be engaged by the bottom surface 24 of an upper block 20b as will be explained below. In this example, two containers 10 are placed on the top surface 22.

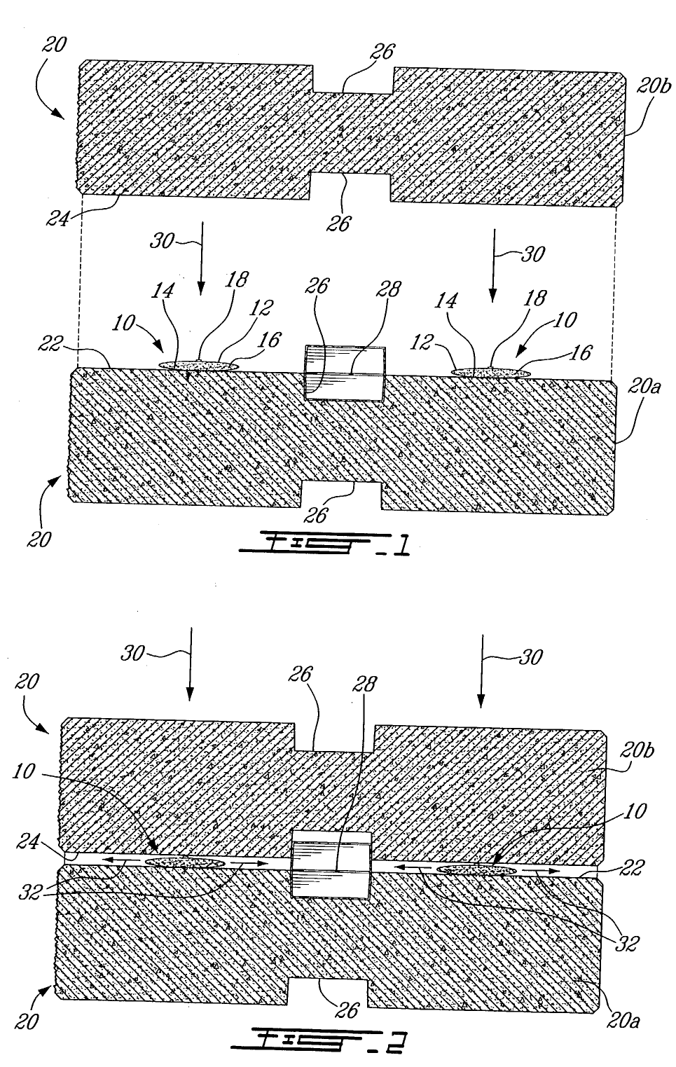

The upper block 20b is then stacked upon the lower block 20b as shown in sequence in FIGS. 1, 2 and 3. The movement of upper block 20b toward the lower block 20a is represented by arrows 30. Hence, container 10 is interposed between the top surface 20 of the lower block 20a and the bottom surface 22 of the upper block 20b. As upper block 20b is stacked upon lower block 20a, the bottom surface 24 of block 20b acts on the weak breaking area 18 consequently breaking it and causing the container body 12 to burst open and release the adhesive material 16 as shown in FIG. 3.

The pressure that blocks 20a and 20b exert on the container body 12 and the internal pressure of the encapsulated adhesive material 16 within cavity 14 causes the adhesive material 16 to shoot out of the container body 12 as body 12 bursts, as represented by arrows 32 in FIG. 2. Hence, the adhesive material 16 spreads on a sufficiently wide surface area between the top and bottom surfaces 22 and 24 of respective blocks 20a and 20b.

After a short wait the adhesive material 16 adheres the two blocks 20a and 20b together.

In this way, a variety of structures, such as walls (not shown) for example, can be built by stacking building blocks 20 together having placed burstable adhesive containers 10 on the top surfaces 22 of the lower blocks 20a in order to adhere every top row of blocks to a bottom row.

With respect to the above-described embodiment, what follows is a brief description of some alternative features that are included, without limitation, within the scope of the present invention.

The container body 12 may be a sac, a cartridge, a blister pad, a capsule, a glue shot container or any other suitable type of body for containing the adhesive material 16. The container body 12 may be provided in a variety of suitable sizes and configurations that will allow to release the adhesive material 16 when bursting as described above.

The container body 12 may be made of a variety of known polymeric or plastic materials that are burstable in accordance with the present invention. As will be understood by the skilled artisan the thickness and material used for body 12 will be chosen on the basis of its capacity to encapsulate the adhesive material and seal it therein so as not to burst or break during normal handling and easily bursting when crushed between two building blocks 20.

The weak breaking area 18 may be any type of weak point in the surface of body 12 or a structure, such as a dart for example, which causes the container body 12 to burst open when acting thereon with sufficient force. Of course, container 10 may be provided without a weak breaking area 18 and may be designed to burst open when crushed between two staked blocks 20.

The adhesive material 16 may be any type of ready to polymerize industrial adhesive liquid or gel that can spread and glue a variety of cement, plastic or other type of building block.

The building blocks 20 do not need to have grooves for connectors and may be provided in other various suitable stackable configurations and sizes. Blocks 20 may be made of a variety of precast materials such as cement, plastic, wood and other materials known to the ordinarily skilled artisan.

With reference to the appended drawings there is shown another embodiment of the adhesive carrier 28 for stackable blocks 20.

In this case, the adhesive carrier 28 is in the form of an interlock connector. The body of the interlock connector 28 includes an outer surface 34 that is coated with an adhesive material 36.

As shown in the interlock container 28 has a generally rectangular configuration, which corresponds the rectangular configuration of grooves 26 and includes similar top and bottom body portions 38 and 40 respectively.

The adhesive material 36 is a pressure sensitive adhesive that is configured to be easily handled by the user without sticking to the hands and to demonstrate its adhesive properties when interposed between two stacked blocks 20a and 20b as shown in FIG. 3 and as described below.

In operation, the bottom body portion 40 of adhesive-carrying interlock connector 28 is snugly fitted within groove 26 formed on the top surface 22 of the lower block 20a. The upper block 20b is then stacked on the lower block 20b. Groove 26, which is formed on the bottom surface 24 of upper block 20b, snugly receives therein the top body portion 38 of the interlock connector 28. Hence, the adhesive-carrying connector 28 is interposed between blocks 20a and 20b and fitted within their respective grooves 26 as shown in FIG. 3.

The weight of the upper block 20b on connector 28 as well as the pressure exerted thereon as it is inserted in the grooves 26 of both blocks 20a and 20b causes the pressure sensitive adhesive material 36 to soften and stick the surface define by grooves 26 of blocks 20a and 20b after a short wait and hence, gluing blocks 20a and 20b together.

The interlock connector can be provided in a variety of configurations so as to correspond to a variety of grooves formed on the top and bottom surface of various types of building blocks.

In a further embodiment, the whole interlock connector 28 may be made of a pressure-sensitive adhesive material 36.

In yet a further embodiment, the adhesive material 36 may be non pressure sensitive and may be a solid designed to soften into a viscous and mouldable adhesive material after chemically reacting when exposed to water or another liquid as is known in the art. After a short wait this viscous and mouldable adhesive material sticks to the blocks 20 and then solidifies adhering two stacked blocks 20 together.

In another embodiment, the adhesive carrier 10 may be a solid piece of a pressure-sensitive adhesive material 16 without an outer body shell 12. In this respect the pressure-sensitive material is flattened, by the weight of block 20b, between the two stacked blocks 20a and 20b adhering these two blocks together.

In yet another embodiment, the carrier 10 made of a solid piece of an adhesive material 16 without an outer body shell 12 may be a solid, designed to soften into a viscous and mouldable adhesive material after chemically reacting, when exposed to water or another liquid as is known in the art.

In a further embodiment, the carrier 10 may include a central solid flat piece of material (not shown), such as plastic, on which an adhesive material 16 is carried, this adhesive material may be a pressure-sensitive adhesive or a solid designed to soften into a viscous and mouldable material as explained above.

A variety of types of adhesive materials known to the person having skill in the art can be used in order to carry out the present invention.

It is to be understood that the invention is not limited in its application to the details of construction and parts illustrated in the accompanying drawings and described hereinabove. The invention is capable of other embodiments and of being practised in various ways. It is also to be understood that the phraseology or terminology used herein is for the purpose of description and not limitation. Hence, although the present invention has been described hereinabove by way of preferred embodiments thereof, it can be modified, without departing from the spirit, scope and nature of the subject invention as defined in the appended claims.

What is claimed is:

1. An adhesive carrier for stackable building blocks having respective top and bottom surfaces, said carrier comprising:
a body defining a cavity; and
an adhesive material contained within said cavity, whereby, when placing said body on the top surface of a lower block and stacking an upper block thereon, said body being so configured and sized as to burst between the two stacked blocks releasing the adhesive material contained therein, thereby adhering the two stacked blocks together.

2. An adhesive carrier according to claim 1, wherein the blocks are made of a material selected from the group consisting of cement, plastic, wood or metal.

3. An adhesive carrier according to claim 1, wherein said body is selected from the group consisting of a sac, a cartridge, a blister pad or a capsule.

4. An adhesive carrier according to claim 1, wherein said body is made of a burstable plastic material.

5. An adhesive carrier according to claim 1, wherein said body includes a weak breaking area, said weak breaking area being so configured as to burst open said body when the bottom surface of the upper block acts thereupon.

6. An adhesive carrier according to claim 1, wherein said adhesive material is selected from the group consisting of: epoxy resin and glue.

7. An adhesive carrier according to claim 1, wherein said cavity contains a predetermined amount of adhesive material.

8. An adhesive carrier for stackable building blocks having respective top and bottom surfaces, said carrier comprising:
a body having an outer surface and
a pressure-sensitive adhesive material mounted to said outer surface,
whereby, when interposing said body between two stacked blocks, the stacked blocks exerting such pressure on said pressure-sensitive adhesive material as to adhere the two stacked blocks to said body.

9. An adhesive carrier according to claim 8, wherein the top and bottom surfaces include respective grooves, said body including top and bottom body portions to be respectively inserted in the bottom surface groove of an upper block and in the top surface of a lower block when the upper block is stacked on the lower block.

10. An adhesive interlock connector for adhesively interconnecting two stackable blocks having top and bottom surfaces with respective grooves, said interlock connector comprising:
a body having top and bottom body portions, said body being made of an adhesive material, wherein said adhesive body is configured to adhere together two stacked blocks when interposed therebetween with said top body portion being inserted in the groove of the bottom surface of an upper staked block and said bottom body portion being inserted in the groove of the top surface of a lower stacked block.

11. An adhesive interlock connector according to claim 10, wherein said adhesive material in selected from the group consisting of pressure sensitive adhesive material and solid adhesive material configured to adhere the block together when chemically reacted with another substance.

12. An adhesive body for adhesively interconnecting two stackable blocks having top and bottom surface, said being made of a solid adhesive material, wherein said adhesive body is configured to adhere together two stacked blocks when interposed between the bottom surface of an upper stacked block and the top surface of a lower stacked block and when chemically reacted with another substance.

13. A method of adhering stackable building blocks together, said blocks having respective top and bottom surfaces, said method comprising:
(a) placing an adhesive carrier on the top surface of one block, said adhesive carrier including a body defining a cavity with adhesive material contained therein; and
(b) stacking another block on the top surface of the one block so as to burst said adhesive carrier body releasing said adhesive material between the to stacked blocks, thereby adhering the two stacked blocks together.

14. A method of adhering stackable building blocks together, said blocks having respective top and bottom surfaces, said method comprising:
(a) placing an adhesive carrier on the top surface of a lower block, said adhesive carrier including a body having an outer surface and including a pressure-sensitive adhesive material mounted to said outer surface,
(b) stacking another block on the top surface of the one block so as to exert such pressure on said pressure-sensitive adhesive material as to adhere the two stacked blocks to said body.

15. A method of adhering stackable building blocks together, said blocks having respective top and bottom surfaces with respective grooves, said method comprising:
(a) placing an adhesive interlock connector on the top surface of one said block, said adhesive interlock connector including a body made of an adhesive material and having top and bottom body portions, said bottom body portion being inserted in said top surface groove;
(b) stacking another said block on said one block such that the bottom surface groove of said another block receives therein said top body portion such that said adhesive body is configured to adhere said two stacked blocks together.

16. A method of adhering stackable building blocks together, said blocks having respective top and bottom surfaces, said method comprising:
(a) placing an adhesive body made of a solid adhesive material, on one said block;
(b) stacking another said block on one said block with said adhesive body interposed therebetween; and
(c) reacting said solid adhesive body with a substance such that said solid adhesive body is configured to adhere together said two stacked blocks when chemically reacted with said substance.
